(19) United States
(12) Patent Application Publication
(10) Pub. No.: US 2023/0105792 A1
(43) Pub. Date: Apr. 6, 2023

(54) CHARGING METHOD AND CHARGING SYSTEM FOR NON-AQUEOUS ELECTROLYTE SECONDARY BATTERY

(71) Applicant: Panasonic Intellectual Property Management Co., Ltd., Osaka-shi, Osaka (JP)

(72) Inventors: Takahiro Fukuoka, Osaka Fu (JP); Akira Kano, Osaka Fu (JP)

(73) Assignee: Panasonic Intellectual Property Management Co., Ltd., Osaka-shi, Osaka (JP)

(21) Appl. No.: 17/802,800

(22) PCT Filed: Feb. 18, 2021
(86) PCT No.: PCT/JP2021/006223

§ 371 Date: Aug. 26, 2022

(30) Foreign Application Priority Data
Feb. 28, 2020 (JP) 2020-034463

(51) Int. Cl. H01M 10/44; H01M 10/052; H01M 4/04; H01M 4/40; H01M 4/525; H01M 4/485; H01M 4/505; H01M 10/0567; H01M 4/66

(52) U.S. Cl. CPC H01M 10/44; H01M 10/052; H01M 4/0404; H01M 4/405; H01M 4/525; H01M 4/485; H01M 4/505; H01M 10/0567; H01M 4/661; H01M 2004/027

(57) ABSTRACT

A charging method for a non-aqueous electrolyte secondary battery. The battery includes a positive electrode, a negative electrode including a negative electrode current collector, and a non-aqueous electrolyte, in which a lithium metal deposits on the negative electrode during charge, and the lithium metal dissolves in the non-aqueous electrolyte during discharge. The method includes first to third steps. In the first step, a constant-current charging is performed at a first current I₁ having a current density of 1.0 mA/cm² or less. In the second step, a constant-current charging is performed at a second current I₂ being larger than the first current I₁ and having a current density of 4.0 mA/cm² or less. In the third step, a constant-current charging is performed at a third current I₃ being larger than the second current I₂ and having a current density of 4.0 mA/cm² or more.

### TECHNICAL FIELD

The present invention relates to a charging method and a charging system for a non-aqueous electrolyte secondary battery.

### BACKGROUND ART

Non-aqueous electrolyte secondary batteries represented by lithium-ion secondary batteries have high energy density and high output, and have been seen as promising power sources for mobile devices such as smartphones, driving power sources for vehicles such as electric cars, and power storage apparatus for storing natural energy such as solar energy.

With an aim to achieve a higher battery capacity, studies have been made on a non-aqueous electrolyte secondary battery of a type in which a lithium metal deposits on a negative electrode current collector during charge and the lithium metal dissolves during discharge (e.g., Patent Literature 1).

### CITATION LIST

### Patent Literature

[Patent Literature 1] Japanese Laid-Open Patent Publication No. 2001-243957

### SUMMARY OF INVENTION

### Technical Problem

However, the deposition form of the lithium metal is difficult to control, and the suppression of dendrite formation and growth has been insufficient. The lithium metal deposited in the form of dendrites on the negative electrode current collector during charge starts to dissolve from the negative electrode current collector side during discharge. Therefore, part of the deposited lithium metal becomes isolated from the negative electrode (conductive network) during discharge, and the capacity tends to decrease. With repeated charge and discharge, the isolation of lithium metal from the negative electrode proceeds, and the cycle characteristics tend to deteriorate.

### Solution to Problem

In view of the above, one aspect of the present invention relates to a charging method for a non-aqueous electrolyte secondary battery, the battery including a positive electrode, a negative electrode including a negative electrode current collector, and a non-aqueous electrolyte, in which a lithium metal deposits on the negative electrode during charge, and the lithium metal dissolves in the non-aqueous electrolyte during discharge, the method including: a charging step including a first step, a second step performed after the first step, and a third step performed after the second step, wherein in the first step, a constant-current charging is performed at a first current I₁ having a current density of 1.0 mA/cm² or less, in the second step, a constant-current charging is performed at a second current I₂ being larger than the first current I₁ and having a current density of 4.0 mA/cm² or less, and in the third step, a constant-current charging is performed at a third current I₃ being larger than the second current I₂ and having a current density of 4.0 mA/cm² or more.

Another aspect of the present invention relates to a charging system for a non-aqueous electrolyte secondary battery, including: a non-aqueous electrolyte secondary battery; and a charging apparatus, wherein the non-aqueous electrolyte secondary battery includes a positive electrode, a negative electrode including a negative electrode current collector, and a non-aqueous electrolyte, in which a lithium metal deposits on the negative electrode during charge, and the lithium metal dissolves in the non-aqueous electrolyte during discharge, and the charging apparatus includes a charging control unit that controls charging such that a first constant-current charging is performed at a first current I₁ having a current density of 1.0 mA/cm² or less, a second constant-current charging is performed after the first constant-current charging, at a second current I₂ being larger than the first current I₁ and having a current density of 4.0 mA/cm² or less, and a third constant-current charging is performed after the second constant-current charging, at a third current I₃ being larger than the second current I₂ and having a current density of 4.0 mA/cm² or more.

### Advantageous Effects of Invention

According to the present invention, the cycle characteristics of the non-aqueous electrolyte secondary battery can be enhanced.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A scanning electron microscope (SEM) image of a negative electrode during charging by a charging method for a non-aqueous electrolyte secondary battery according to one embodiment of the present invention. FIG. 1A shows a deposited state of lithium metal when a charge rate is 5%. FIG. 1B shows a deposited state of lithium metal when the charge rate is 50%.

FIG. 2 A SEM image of a negative electrode during charging by the conventional charging method for a non-aqueous electrolyte secondary battery. FIG. 2A shows a deposited state of lithium metal when the charge rate is 5%. FIG. 2B shows a deposited state of lithium metal when the charge rate is 50%.

FIG. 3 A schematic block diagram of a charging system for a non-aqueous electrolyte secondary battery according to one embodiment of the present invention.

FIG. 4 A partially cut-away schematic oblique view of a non-aqueous electrolyte secondary battery used in the charging method and the charging system according to one embodiment of the present invention.

### DESCRIPTION OF EMBODIMENTS

### [Charging Method for Non-Aqueous Electrolyte Secondary Battery]

The charging method for a non-aqueous electrolyte secondary battery according to one embodiment of the present invention relates to a charging method for a non-aqueous electrolyte secondary battery including a positive electrode, a negative electrode including a negative electrode current collector, and a non-aqueous electrolyte, in which a lithium metal deposits on the negative electrode during charge, and the lithium metal dissolves in the non-aqueous electrolyte during discharge. The above charging method (charging step) includes three constant-current charging steps of first to third steps. In the first step, a constant-current charging is performed at a first current I₁. In the second step, a constant-current charging is performed after the first step, at a second current I₂ larger than the first current I₁. In the third step, a constant-current charging is performed after the second step, at a third current I₃ larger than the second current I₂. The first current I₁ has a current density J₁ of 1.0 mA/cm² or less. The second current I₂ has a current density J₂ of 4.0 mA/cm² or less. The third current I₃ has a current density J₃ of 4.0 mA/cm² or more.

The current density (mA/cm²) is a current density per unit facing area (1 cm²) between the positive electrode and the negative electrode, and is determined by dividing the current value applied to the battery, by the total area of a positive electrode mixture layer(s) (or a positive electrode active material layer(s)) facing the negative electrode (hereinafter sometimes referred to as an effective total area of the positive electrode). The effective total area of the positive electrode is, for example, when the positive electrode has a positive electrode mixture layer on both sides of the positive electrode current collector, a total area of the positive electrode mixture layers on both sides (i.e., a sum of the projected areas of the positive electrode mixture layers on both sides, as projected on one and the other surfaces of the positive electrode current collector, respectively).

Specifically, for example, in the first step, the constant-current charging is performed at the first current I₁ of 0.1 C or less. In the second step, the constant-current charging is performed at the second current I₂ being larger than the first current I₁ and 0.4 C or less. In the third step, the constant-current charging is performed at the third current I₃ being larger than the second current I₂ and 0.4 C or more.

When the above first to third steps of constant-current charging are performed, the isolation of lithium metal from the negative electrode during discharge can be suppressed, and the reduction in capacity due to the isolation can be suppressed. The deterioration in cycle characteristics due to the progress of the above isolation with repeated charge and discharge can be suppressed.

In the first step, the current density J₁ in the first current I₁ is as small as 1.0 mA/cm² or less, and a lithium metal tends to deposit in a massive form (particulate form) on the negative electrode current collector. The massive Li is less likely to be isolated during discharge. In the second step and the third step (esp. the third step), in which the current value is large, the dendritic Li deposits to some extent. The dendric Li, however, deposits on the massive Li deposited at the initial stage of charging (mainly in the first step) and tends to be firmly integrated with the massive Li, and the isolation of Li is suppressed during discharge.

By providing the second step of performing charging at the second current smaller than the third current between the first step and the third step, the dendrite formation and growth can be suppressed. In the second step, too, a massive Li may deposit in some cases, depending on the magnitude of the charging current (e.g., 0.2 C or less).

By increasing the current value in the order of the second step to the third step, charging can be done efficiently in a short time. In view of shortening the charge time, the current density J₂ in the second current I₂ may be 2.0 mA/cm² or more. In view of shortening the charge time, the second current I₂ may be 0.2 C or more. However, when the current density J₂ exceeds 4.0 mA/cm², the dendrite formation and growth becomes severe in the second and subsequent steps, causing deterioration in the cycle characteristics in some cases. When the current density J₃ in the third current I₃ is 4.0 mA/cm² or more, the charge time can be shortened while excellent cycle characteristics are maintained. In this case, the third current I₃ may be 0.4 C or more. In view of suppressing the dendrite formation and growth, the current density J₃ may be 6.0 mA/cm² or less. In view of suppressing the dendrite formation and growth, the third current I₃ may be 0.6 C or less.

When, in the constant-current charging step, three steps of the first to third steps are provided, and the above first to third currents are set, improved cycle characteristics and a shorter charge time can be both achieved.

Here, (1/X) C represents a current value used when the amount of electricity corresponding to the rated capacity is constant-current charged or discharged in X hour(s). For example, 0.1 C is a current value used when the amount of electricity corresponding to the rated capacity is constant-current charged or discharged in 10 hours.

The current density J₁ in the first current I₁ may be, for example, 0.1 mA/cm² or more and 0.8 mA % cm² or less, and may be 0.1 mA/cm² or more and 0.5 mA/cm² or less. The current density J₂ in the second current I₂ may be, for example, 1.0 mA/cm² or more and 2.0 mA/cm² or less. The current density J₃ in the third current I₃ may be, for example, 8.0 mA/cm² or more and 10.0 mA/cm² or less.

The first current I₁ may be, for example, 0.01 C or more and 0.08 C or less, and may be 0.01 C or more and 0.05 C or less. The second current I₂ may be, for example, 0.1 C or more and 0.2 C or less. The third current I₃ may be 0.8 C or more and 1.0 C or less.

In view of efficiently performing the three-step constant-current charging, a ratio I₂/I₁ of the second current I₂ to the first current I₁ may be, for example, 1.25 or more, and may be 1.25 or more and 4 or less. Likewise, a ratio I₃/I₂ of the third current I₃ to the second current I₂ may be, for example, 3 or more, and may be 3 or more and 10 or less.

Usually, the battery is fully charged by the charging step. A fully charged battery means a battery charged to a voltage (e.g., 4.1 V) at which the amount of electricity corresponding to the rated capacity is estimated to have been charged. A full charge amount means an amount of electricity charged in a battery from a frilly discharged state to the fully charged state. A fully discharged battery means a battery discharged to a voltage (e.g., 3 V) at which the amount of electricity corresponding to the rated capacity is estimated to have been discharged. Hereinafter, a ratio of the amount of charged electricity to the full charge amount is referred to as a charge rate. In the fully charged state, the charge rate is 100%. In the fully discharged state, the charge rate is 0%.

The timing of ending each step of the constant-current charging may be controlled, for example, by the charge time, the amount of electricity to be charged, or the voltage. The timing may be controlled by the ratio of the amount of charged electricity to the total amount of electricity to be charged in the charging step, or by the charge rate. The amount of charged electricity (charge rate) may be estimated from the voltage. An end-of-charge voltage in each step may be set by estimating the amount of charged electricity (charge rate) from the voltage, based on the relationship between the amount of charged electricity and the voltage when an initial battery is constant-current charged to the rated capacity (charge rate: 100%). For example, the end-of-charge voltage in the final step (third step) of the constant-current charging may be set to a voltage at which the amount of electricity corresponding to the rated capacity is estimated to have been charged, based on the relationship between the amount of charged electricity and the voltage when an initial battery is constant-current charged to the rated capacity.

In the first step, the constant-current charging may be performed such that the amount of electricity to be charged in the first step becomes 15% or less of the total amount of electricity to be charged in the charging step (the amount of total electricity to be charged in the charging step). In the second step, the constant-current charging may be performed such that the summed amount of charged electricity in the first step and the second step becomes 50% or less of the total amount of electricity to be charged in the charging step. In this case, the first step to the third step can be performed in a well-balanced manner, and the cycle characteristics can be effectively improved. In the charging step, the amount of electricity corresponding to the full charge amount may be charged, and the total amount of electricity to be charged in the above charging step may be the full charge amount.

In order to perform charging more reliably, the above charging method may further include a constant-voltage charging step of performing charging at a constant voltage after the constant-current charging step (third step). The constant-voltage charging is performed, for example, until the current reaches a predetermined value (e.g., 0.02 C). For example, when the third step is performed to a predetermined voltage V₃, the constant-voltage charging may be performed at the voltage V₃. The voltage V₃ is, for example, 4.1 V.

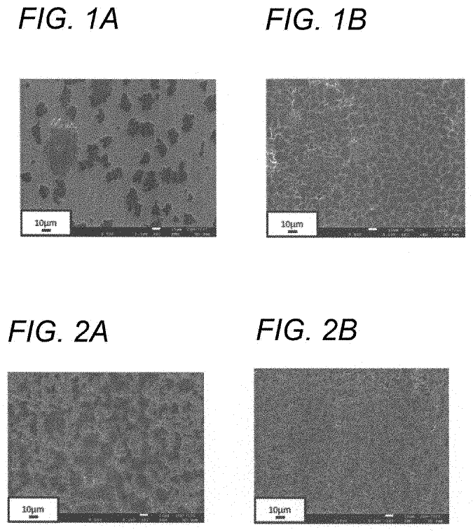

Here, FIG. 1 is a SEM image of a negative electrode during charging by a charging method for a non-aqueous electrolyte secondary battery according to one embodiment of the present invention. FIGS. 1A and 1B show deposited states of lithium metal at some point (charge rate: 5%) in the first step (0.05 C (0.5 mA/cm²) charging) and at the end point (charge rate: 50%) of the second step (0.4 C (4.0 mA/cm²) charging), respectively, in the case where the charging is performed in a similar manner to in Example 2. On the other hand, FIG. 2 is a SEM image of a negative electrode during charging by the conventional charging method. FIGS. 2A and 2B show deposited states of lithium metal when the charge rates are 5% and 50%, respectively, in the constant-current charging step (0.2 C (2.0 mA/cm²) charging), in the case where the charging is performed in a similar manner to in Comparative Example 2.

FIG. 1A indicates that according to the charging method for a non-aqueous electrolyte secondary battery of an embodiment of the present invention, when the charge rate at the initial stage of charging is as small as 0.5 mA/cm², a lithium metal is likely to deposit in a massive form on the negative electrode current collector at the initial stage of charging. FIG. 1B indicates that even when the charge rate in the second step is set higher than in the first step, since new lithium deposits on the massive lithium metal deposited at the initial stage of charging, and the newly deposited lithium tends to be firmly integrated with the massive lithium metal, a dendritic lithium is unlikely to deposit. On the other hand, FIGS. 2A and 2B indicates that according to the conventional charging method, in which the charge rate at the initial stage of charging is as high as 2.0 mA/cm², a lithium metal is likely to deposit in a dendritic form on the negative electrode current collector at the initial stage of charging.

[Charging System for Non-Aqueous Electrolyte Secondary Battery]

A charging system for a non-aqueous electrolyte secondary battery according to one embodiment of the present invention includes a non-aqueous electrolyte secondary battery and a charging apparatus. The non-aqueous electrolyte secondary battery includes a positive electrode, a negative electrode including a negative electrode current collector, and a non-aqueous electrolyte, in which a lithium metal deposits on the negative electrode during charge, and the lithium metal dissolves in the non-aqueous electrolyte during discharge. The charging apparatus includes a charging control unit that controls charging such that a first constant-current charging is performed at a first current I₁ having a current density of 1.0 mA/cm² or less, a second constant-current charging is performed after the first constant-current charging, at a second current I₂ being larger than the first current I₁ and having a current density of 4.0 mA/cm² or less, and a third constant-current charging is performed after the second constant-current charging, at a third current I₃ being larger than the second current I₂ and having a current density of 4.0 mA/cm² or more. For example, the first current I₁ is 0.1 C or less. The second current I₂ is larger than the first current I₁, and is 0.4 C or less. The third current I₃ is larger than the second current I₂, and is 0.4 C or more.

The charging control unit controls charging such that when the amount of charged electricity reaches a first threshold value in the first constant-current charging, the first constant-current charging is ended to start the second constant-current charging, and when the amount of charged electricity reaches a second threshold value in the second constant-current charging, the second constant-current charging is ended to start the third constant-current charging. The first threshold value is, for example, an amount of charged electricity corresponding to 15% or less of the total amount of electricity to be charged, and the second threshold value is, for example, an amount of charged electricity corresponding to 50% or less of the total amount of electricity to be charged.

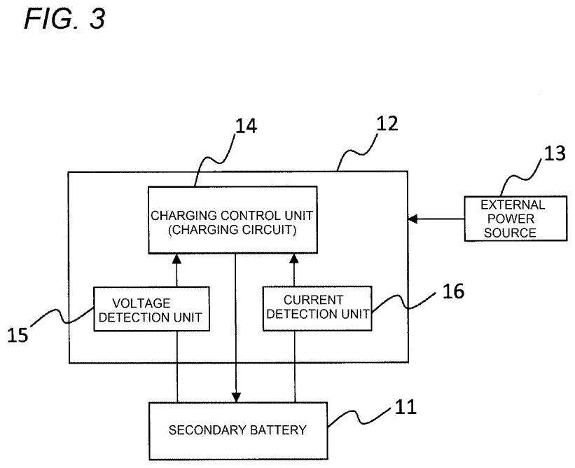

FIG. 3 illustrated an example of a charging system for a non-aqueous electrolyte secondary battery according to an embodiment of the present invention.

The charging system includes a non-aqueous electrolyte secondary battery 11, and a charging apparatus 12. To the charging apparatus 12, an external power source 13 that supplies power to the charging apparatus 12 is connected. The non-aqueous electrolyte secondary battery 11 includes a positive electrode, a negative electrode including a negative electrode current collector, and a non-aqueous electrolyte, in which a lithium metal deposits on the negative electrode during charge, and the lithium metal dissolves in the non-aqueous electrolyte during discharge. The charging apparatus 12 includes a charging control unit 14 including a charging circuit.

The charging control unit 14 controls charging such that a first constant-current charging is performed at a first current I₁, a second constant-current charging is performed at a second current I₂ after the first constant-current charging, and a third constant-current charging is performed at a third current I₃ after the second constant-current charging. The first current I₁ has a current density of 1.0 mA/cm² or less. The second current I₂ is larger than the first current I₁ and has a current density of 4.0 mA/cm² or less. The third current I₃ is larger than the second current I₂ and has a current density of 4.0 mA/cm² or more.

The charging apparatus 12 includes a voltage detection unit 15 that detects a voltage of the non-aqueous electrolyte secondary battery 11. The voltage detection unit 15 may include an arithmetic unit that calculates an amount of charged electricity (charge rate), based on the voltage. Based on the voltage detected by the voltage detection unit 15 (the amount of charged electricity determined by the arithmetic unit), by the charging control unit 14, the first constant-current charging is switched to the second constant-current charging, the second constant-current charging is switched to the third constant-current charging, and the third constant-current charging is ended.

The charging control unit 14 controls such that a constant-voltage charging is performed after the third constant-current charging, at a predetermined voltage (e.g., an end-of-charge voltage of the third constant-current charging). The charging apparatus 12 includes a current detection unit 16 that detects a current. The constant-voltage charging is ended by the charging control unit 14, when the current detected by the current detection unit 16 reaches a threshold value.

In FIG. 3, the timings of ending of the first constant-current charging to the third constant-current charging are controlled by the voltage detected by the voltage detection unit 15, but may be controlled by the charge time. For example, the ending of the first constant-current charging and the second constant-current charging may be controlled by the charge time, and the ending of the third constant-current charging may be controlled by the voltage.

A detailed description will be given below of each component element of the non-aqueous electrolyte secondary battery.

### [Negative Electrode]

The negative electrode includes a negative electrode current collector. In a lithium secondary battery, a lithium metal deposits, for example, on a surface of the negative electrode current collector during charge. Specifically, lithium ions contained in the non-aqueous electrolyte receive electrons on the negative electrode current collector during charge and become a lithium metal, which deposits on the surface of the negative electrode current collector. The lithium metal deposited on the surface of the negative electrode current collector dissolves as lithium ions during discharge in the non-aqueous electrolyte. The lithium ions contained in the non-aqueous electrolyte may be either derived from a lithium salt added to the non-aqueous electrolyte or supplied from the positive electrode active material during charge, or both.

The negative electrode current collector is an electrically conductive sheet. The conductive sheet may be in the form of a foil, film, and the like. The negative electrode current collector may have any thickness; the thickness is, for example, 5 μm or more and 300 μm or less.

The conductive sheet may have a smooth surface. In this case, during charge, the lithium metal derived from the positive electrode tends to uniformly deposit on the conductive sheet. The smooth surface means that the conductive sheet has a maximum height roughness Rz of 20 μm or less. The conductive sheet may have a maximum height roughness Rz of 10 μm or less. The maximum height roughness Rz is measured in accordance with JIS B 0601: 2013.

The negative electrode current collector (conductive sheet) is made of an electrically conductive material other than lithium metal and lithium alloys. The conductive material may be a metal material, such as a metal and an alloy. The conductive material is preferably not reactive with lithium. Specifically, a material that forms neither an alloy nor an intermetallic compound with lithium is preferred. Such a conductive material is exemplified by copper (Cu), nickel (Ni), iron (Fe), and an alloy of one or more of these metal elements, or graphite having a basal plane predominately exposed on its surface. Examples of the alloy include a copper alloy and stainless steel (SUS). Preferred are copper and/or a copper alloy because of its high electrical conductivity.

The negative electrode may include a negative electrode current collector (e.g., a copper foil or a copper alloy foil), and a sheet of lithium metal (hereinafter sometimes referred to as a Li sheet) which is brought into close contact with a surface of the negative electrode current collector by pressure bonding or the like. A Li sheet is disposed in advance on a surface of the negative electrode current collector, and a lithium metal (mostly in the form of massive Li, and may slightly contain dendritic Li) is allowed to deposit on the Li sheet during charge. Deposited Li tends to be firmly integrated with the Li sheet, and the isolation of the deposited Li can be further suppressed. In view of the cost and the ease of integration with the deposited lithium metal, the thickness of the Li sheet is preferably, for example, 5 μm or more and 25 μm or less.

### [Positive Electrode]

The positive electrode includes a positive electrode active material capable of absorbing and releasing lithium ions. The positive electrode active material is, for example, a composite oxide containing lithium and a metal Me other than lithium. The metal Me includes at least a transition metal. The composite oxide has, for example, a layered rock-salt type crystal structure. The composite oxide is inexpensive in production cost and advantageous in its high average discharge voltage.

The lithium contained in the composite oxide is released as lithium ions from the positive electrode, during charge, and deposits as a lithium metal at the negative electrode. During discharge, the lithium metal dissolves from the negative electrode and releases lithium ions, which are absorbed in the composite oxide in the positive electrode. That is, the lithium ions involved in charging and discharging are mostly derived from the solute (lithium salt) in the non-aqueous electrolyte and the positive electrode active material. Therefore, a molar ratio mLi/mMe of an amount mLi of total lithium in the positive electrode and the negative electrode to an amount mMe of the metal Me in the positive electrode is, for example, 1.2 or less.

The transition metal may include nickel (Ni), and at least one element selected from the group consisting of cobalt (Co), manganese (Mn), iron (Fe), copper (Cu), chromium (Cr), titanium (Ti), niobium (Nb), zirconium (Zr), vanadium (V), tantalum (Ta), tungsten (W), and molybdenum (Mo).

The metal Me may include a metal other than transition metals. The metal other than transition metals may include at least one selected from the group consisting of aluminum (Al), magnesium (Mg), calcium (Ca), strontium (Sr), zinc (Zn), and silicon (Si). The composite oxide may further contain boron (B) or the like, in addition to the metal.

In view of achieving a higher capacity, the composite oxide preferably has a layered rock-salt type crystal structure, in which the metal Me other than lithium preferably at least includes nickel as a transition metal, and an atomic ratio Ni/Me of Ni to the metal Me may be 0.65 or more. When using a nickel-based composite oxide in which the Ni/Me is 0.65 or more, the initial charge-discharge efficiency is lower than when using lithium cobaltate, and the lithium metal deposited on the negative electrode current collector (mainly, the massive Li deposited in the initial stage of charging) tends to remain thereon during discharge. When its amount is large, the remaining lithium metal can exhibit a similar effect to that of the above Li sheet which is brought into close contact with the negative electrode current collector. In the composite oxide, the atomic ratio Ni/Me of Ni to the metal Me is preferably 0.65 or more and less than 1, more preferably 0.7 or more and less than 1, and further more preferably 0.8 or more and less than 1.

In view of achieving a higher capacity and improving the output characteristics, in particular, the metal Me preferably includes Ni and at least one selected from the group consisting of Co, Mn and Al, and more preferably includes Ni, Co, and Mn and/or Al. When the metal Me includes Co, during charge and discharge, the phase transition of the composite oxide containing Li and Ni can be suppressed, the stability of the crystal structure can be improved, and the cycle characteristics tends to be improved. When the metal Me includes Mn and/or Al, the thermal stability can be improved.

The composite oxide may have a composition represented by a general formula (1): LiₐNi_{b}M_{1-b}O₂, where 0.9≤a≤1.2, and 0.65≤b≤1, and M is at least one element selected from the group consisting of Co, Mn, Al, Ti, Fe, Nb, B, Mg, Ca, Sr. Zr, and W. The ratio of Ni occupying the metals other than Li is large, and the massive Li tends to remain during discharge. Furthermore, in this case, a higher capacity can be easily achieved, and the effects produced by Ni and the effect produced by the element M can be obtained in a well-balanced manner.

The composite oxide may have a composition represented by a general formula (2): LiₐNi_{1-y-z}Co_{y}Al_{z}O₂, where 0.9≤a≤1.2, 0<y≤0.2, 0<z≤0.05, and y+z≤0.2. When y representing the composition ratio of Co is greater than 0 and 0.2 or less, high capacity and high output tends to be maintained, and the stability of the crystal structure during charge and discharge tends to be improved. When z representing the composition ratio of Al is greater than 0 and 0.05 or less, high capacity and high output tends to be maintained, and the thermal stability tends to be improved. In the formula, (1-y-z) representing the composition ratio of Ni satisfies 0.8 or greater and less than 1. In this case, the ratio of Ni occupying the metals other than Li is large, and the deposition form of Li is likely to be controlled. Also, in this case, a higher capacity is likely to be achieved, and the effects produced by Ni and the effect produced by Co and Al can be obtained in a well-balanced manner.

As the positive electrode active material, other than the above composite oxide, for example, a transition metal fluoride, a polyanion, a fluorinated polyanion, a transition metal sulfide, or the like may be used.

The positive electrode includes, for example, a positive electrode current collector and a positive electrode mixture layer supported on the positive electrode current collector. The positive electrode mixture layer contains, for example, a positive electrode active material, a conductive agent, and a binder. The positive electrode mixture layer may be formed on one surface or both surfaces of the positive electrode current collector. The positive electrode can be obtained by, for example, applying a positive electrode mixture slurry containing a positive electrode active material, a conductive agent, and a binder onto a surface of the positive electrode current collector, drying the applied film, and then rolling.

The conductive agent is, for example, a carbon material. Examples of the carbon material include carbon black, acetylene black, Ketjen black, carbon nanotubes, and graphite.

Examples of the binder include a fluorocarbon resin, polyacrylonitrile, a polyimide resin, an acrylic resin, a polyolefin resin, and a rubbery polymer. Examples of the fluorocarbon resin include polytetrafluoroethylene, and polyvinylidene fluoride.

The positive electrode current collector is an electrically conductive sheet. The conductive sheet may be in the form of a foil, film, and the like. The surface of the positive electrode current collector may be coated with a carbon material. The positive electrode current collector may have any thickness; the thickness is, for example, 5 μm or more and 300 μm or less.

The positive electrode current collector (conductive sheet) may be made of, for example, a metal material including Al, Ti, Fe, and the like. The metal material may be Al, an Al alloy, Ti, a Ti alloy, a Fe alloy, and the like. The Fe alloy may be stainless steel (SUS).

### [Separator]

A separator may be disposed between the positive electrode and the negative electrode. The separator is a porous sheet having ion permeability and electrically insulating properties. The porous sheet may be in the form of for example, a microporous thin film, a woven fabric, and a nonwoven fabric. The separator is made of any material, and may a polymer material. Examples of the polymer material include an olefinic resin, a polyamide resin, and a cellulose. Examples of the olefinic resin include polyethylene, polypropylene, and an ethylene-propylene copolymer. The separator may include an additive, if necessary. The additive is, for example, an inorganic filler.

### [Non-Aqueous Electrolyte]

The non-aqueous electrolyte having lithium ion conductivity includes, for example, a non-aqueous solvent, and lithium ions and anions dissolved in the non-aqueous solvent. The non-aqueous electrolyte may be liquid, and may be gel.

The liquid non-aqueous electrolyte can be prepared by dissolving a lithium salt in the non-aqueous solvent. When the lithium salt is dissolved in the non-aqueous solvent, lithium ions and anions are produced.

The gel non-aqueous electrolyte includes a lithium salt and a matrix polymer, or includes a lithium salt, a non-aqueous solvent, and a matrix polymer. The matrix polymer is, for example, a polymer material that is gelled by absorbing the non-aqueous solvent. Examples of the polymer material include a fluorocarbon resin, an acrylic resin, and a polyether resin.

The lithium salt or anions may be any known one that is utilized for a non-aqueous electrolyte in a lithium secondary battery. Specific examples thereof include: BF₄⁻, ClO₄⁻, PF₆⁻, CF₃SO₃⁻, CF₃CO₂⁻, imide anions, and an oxalate complex anion. Examples of the imide anions include N(SO₂F)₂⁻, N(SO₂CF₃)₂⁻, N(CₘF₂ₘ₊₁SO₂)ₓ(CₙF₂ₙ₊₁SO₂)_{y}⁻, where m and n are independently 0 or an integer of 1 or greater, x and y are independently 0, 1 or 2, and x+y=2. The oxalate complex anion may contain boron and/or phosphorus. Examples of the oxalate complex anion include bis(oxalate)borate anion: B(C₂O₄)₂⁻, and difluoro(oxalate)borate anion: BF₂(C₂O₄)⁻, PF₄(C₂O₄)⁻, and PF₂(C₂O₄)₂⁻. The non-aqueous electrolyte may include one of these anions, or two or more kinds thereof.

In view of suppressing the deposition of lithium metal in a dendritic form, the non-aqueous electrolyte preferably includes at least an oxalate complex anion. In particular, difluoro(oxalate)borate anion is more preferred. Due to the interaction between the oxalate complex anion and lithium, a lithium metal is more likely to deposit uniformly in a massive form (particulate form). Therefore, a local deposition of lithium metal tends to be suppressed. The oxalate complex anion may be used in combination with another anion. The other anion may be, for example, PF₆⁻ and/or imide anions, such as N(SO₂F)₂⁻.

Examples of the non-aqueous solvent include esters, ethers, nitriles, amides, and halogen substituted derivatives of these. The non-aqueous electrolyte may contain one of these non-aqueous solvents, or two or more kinds thereof. Examples of the halogen substituted derivatives include fluorides.

The ester includes, for example, a carbonic acid ester, a carboxylic acid ester, and the like. Examples of a cyclic carbonic acid ester include ethylene carbonate and propylene carbonate. Examples of a chain carbonic acid ester include dimethyl carbonate (DMC), ethyl methyl carbonate (EMC), and diethyl carbonate. Examples of a cyclic carboxylic acid ester include γ-butyrolactone and γ-valerolactone. Examples of a chain carboxylic acid ester include ethyl acetate, methyl propionate, and methyl fluoropropionate.

The ether includes a cyclic ether and a chain ether. Examples of the cyclic ether include 1,3-dioxolane, 4-methyl-1,3-dioxolane, tetrahydrofuran, and 2-methyltetrahydrofuran. Examples of the chain ether include 1,2-dimethoxyethane, diethyl ether, ethyl vinyl ether, methyl phenyl ether, benzyl ethyl ether, diphenyl ether, dibenzyl ether, 1,2-diethoxyethane, and diethylene glycol dimethyl ether.

The non-aqueous solvent may contain a small amount of components, such as vinylene carbonate (VC), fluoroethylene carbonate (FEC), and vinyl ethyl carbonate (VEC). In this case, a surface film derived from the above components is formed on the negative electrode, and the dendrite formation is suppressed by the surface film.

The concentration of lithium salt in the non-aqueous electrolyte is, for example, 0.5 mol/L or more and 3.5 mol/L or less. The anion concentration in the non-aqueous electrolyte may be set to 0.5 mol/L or more and 3.5 mol/L or less. The oxalate complex anion concentration in the non-aqueous electrolyte may be set to 0.05 mol/L or more and 1 mol/L or less.

The non-aqueous electrolyte secondary battery, for example, has a structure in which an electrode group formed by winding the positive electrode and the negative electrode with the separator interposed therebetween is housed in an outer body, together with the non-aqueous electrolyte. The wound-type electrode group may be replaced with a different form of electrode group, for example, a stacked-type electrode group formed by stacking the positive electrode and the negative electrode with the separator interposed therebetween. The non-aqueous electrolyte secondary battery may be in any form, such as cylindrical type, prismatic type, coin type, button type, or laminate type.

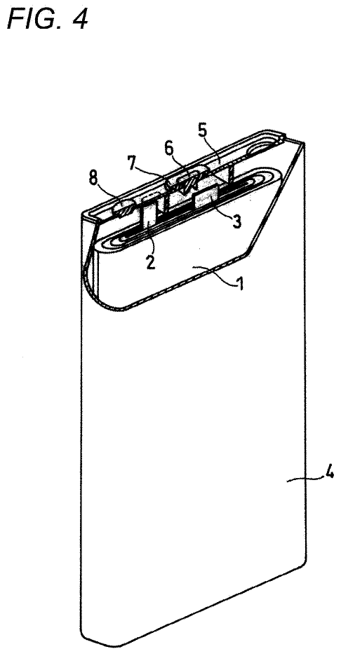

FIG. 4 is a partially cut-away schematic oblique view of a non-aqueous electrolyte secondary battery according to one embodiment of the present invention. A prismatic battery is shown as an example of the non-aqueous electrolyte secondary battery.

The battery includes a bottomed prismatic battery case 4, and an electrode group 1 and a non-aqueous electrolyte (not shown) housed in the battery case 4. The electrode group 1 has a long negative electrode, a long positive electrode, and a separator interposed between the positive electrode and the negative electrode and preventing them from directly contacting with each other. The electrode group 1 is formed by winding the negative electrode, the positive electrode, and the separator around a flat plate-like winding core, and then removing the winding core.

A negative electrode lead 3 is attached at its one end to the negative electrode current collector of the negative electrode, by means of welding or the like. The negative electrode lead 3 is electrically connected at its other end to a negative electrode terminal 6 disposed at a sealing plate 5, via a resin insulating plate (not shown). The negative electrode terminal 6 is insulated from the sealing plate 5 by a resin gasket 7. A positive electrode lead 2 is attached at its one end to the positive electrode current collector of the positive electrode, by means of welding or the like. The positive electrode lead 2 is electrically connected at its other end to the back side of the sealing plate 5, via the insulating plate. In short, the positive electrode lead 2 is electrically connected to the battery case 4 serving as a positive electrode terminal. The insulating plate serves to insulate the electrode group 1 from the sealing plate 5, as well as to insulate the negative electrode lead 3 from the battery case 4. The peripheral edge of the sealing plate 5 is fitted to the opening end of the battery case 4, and the fitting portion is laser-welded. In this way, the opening of the battery case 4 is sealed with the sealing plate 5. A non-aqueous electrolyte injection port provided in the sealing plate 5 is closed with a sealing stopper 8.

### EXAMPLES

The present invention will be specifically described below with reference to Examples. It should be noted, however, that the present invention is not limited to the following Examples.

### Example 1

### [Production of Positive Electrode]

A lithium-nickel composite oxide (LiNi_{0.9}Co_{0.05}Al_{0.05}O₂), acetylene black and polyvinylidene fluoride (PVdF) were mixed in a mass ratio of 95:2.5:2.5, to which N-methyl-2-pyrrolidone (NMP) was added, and then stirred, to prepare a positive electrode slurry. Next, the positive electrode slurry was applied onto a surface of an Al foil serving as a positive current collector, and the applied film was dried, and then rolled. Thus, a positive electrode with a positive electrode mixture layer (density: 3.6 g/cm³) formed on both surfaces of the Al foil was produced.

### [Production of Negative Electrode]

An electrolytic copper foil (thickness: 10 μm) was cut in a predetermined electrode size, to obtain a negative electrode current collector.

### [Preparation of Non-Aqueous Electrolyte]

A non-aqueous electrolyte was prepared by dissolving a lithium salt in a mixed solvent. For the mixed solvent, a mixture of fluoroethylene carbonate (FEC), ethyl methyl carbonate (EMC), and dimethyl carbonate (DMC) in a volume ratio of FEC:EMC:DMC=20:5:75 was used. For the lithium salt, LiPF₆, LiN(FSO₂)₂ (hereinafter, LiFSI), and LiBF₂(C₂O₄) (hereinafter, LiFOB) were used in combination. The concentration of LiPF₆ in the non-aqueous electrolyte was set to 0.5 mol/L. The concentration of LiFSI in the non-aqueous electrolyte was set to 0.5 mol/L. The content of LiFOB in the non-aqueous electrolyte was set to I mass %.

### [Assembly of Battery]

A positive electrode lead made of Al was attached to the positive electrode obtained above, and a negative electrode lead made of Ni was attached to the negative electrode obtained above. In an inert gas atmosphere, the positive and negative electrodes were spirally wound, with a polyethylene thin film (separator) interposed therebetween, to prepare a wound electrode group. The electrode group was housed in a bag-shaped outer body formed of a laminated sheet having an Al layer, into which the non-aqueous electrolyte was injected, and then, the outer body was sealed. A non-aqueous electrolyte secondary battery was thus fabricated. When the electrode group was housed in the outer body, part of the positive electrode lead and part of the negative electrode lead were exposed outside from the outer body.

The lithium contained in the electrode group was all derived from the positive electrode, and the molar ratio mLi/mMe of the amount mLi of total lithium in the positive electrode and the negative electrode to the amount mMe of the metal Me (here, Ni, Co and Al) in the positive electrode was 0.8.

Using the obtained non-aqueous electrolyte secondary battery, in a 25° C. environment, a charge-discharge cycle test was performed as follows.

### [Charge-Discharge Cycle Test]

### (Charging)

First, the following first to third steps of constant-current charging were performed.

First step: constant-current charging at a first current I₁ of 0.1 C (1.0 mA/cm²) to a first charge rate X₁ of the charge rate 15%.

Second step: constant-current charging at a second current I₂ of 0.4 C (4.0 mA/cm²) to a second charge rate X₂ of the charge rate 50%.

Third step: constant-current charging at a third current I₃ of 0.6 C (6.0 mA/cm²) to a third charge rate X₃ of the charge rate 100%.

The ending of the first step and the second step was controlled by the charge time. The charge time (hr) was set to a time calculated by (1/I)·(X/100), given that the amount of electricity corresponding to a charge rate X (%) is charged at a current value I (C). The ending of the third step was controlled by the voltage. Specifically, in the third step, a constant-current charging was performed until the voltage reached 4.1 V, at which the charge rate is estimated as 100%.

Next, after the above constant-current charging, a constant-voltage charging was performed at a voltage of 4.1 V until the current reached 0.02 C.

### (Discharging)

After the rest for 10 minutes, a constant-current discharging was performed at 0.6 C until the voltage reached 3 V.

### [Evaluation]

With the above charging and discharging taken as one cycle, 100 cycles were performed in total. The ratio of the discharge capacity at the 100th cycle to the discharge capacity at the 1st cycle was determined as a capacity retention ratio. In addition, the total charge time (the sum of the times for constant-current charging and constant-voltage charging) at the 100th cycle was determined.

### Example 2, Comparative Example 1

The currents I₁ to I₃ and the charge rates X₁ to X₃ of each step were set as shown in Table 1. In Example 2, the first current I₁ was set to 0.05 C (0.5 mA/cm²), and in Comparative Example 1, the first current I₁ was set to 0.15 C (1.5 mA/cm²). The charge time of each step was set to the time determined in a similar manner to in Example 1. Except for the above, the charge-discharge cycle test was performed in the same manner as in Example 1, and evaluated. In the charge-discharge cycle test, the non-aqueous electrolyte secondary battery as used in Example 1 was used.

### Comparative Example 2

A charge-discharge cycle test was performed in the same manner as in Example 1, except that instead of the constant-current charging consisting of the first to third steps, a constant-current charging was performed at a current of 0.2 C (2.0 mA/cm²) until the voltage reached 4.1 V (to the charge rate 100%), and evaluated. In the charge-discharge cycle test, the non-aqueous electrolyte secondary battery as used in Example 1 was used.

The evaluation results of Examples 1 and 2 and Comparative Examples 1 and 2 are shown in Table 1.

In Examples 1 and 2, a higher capacity retention ratio was obtained as compared to in Comparative Examples 1 and 2. In Comparative Examples 1 and 2, in which the current density at the initial stage of charging (first step) was as high as exceeding 1.0 mA/cm², the Li dendrite formation was severe, which resulted in a low capacity retention ratio.

### Example 3, Comparative Example 3

The currents I₁ to I₃ and the charge rates X₁ to X₃ of each step were set as shown in Table 2. In Example 3, the second current I₂ was set to 0.2 C (2.0 mA/cm²), and in Comparative Example 3, the second current I₂ was set to 0.6 C (6.0 mA/cm²). The charge time of each step was set to the time determined in a similar manner to in Example 1. Except for the above, the charge-discharge cycle test was performed in the same manner as in Example 1, and evaluated. In the charge-discharge cycle test, the non-aqueous electrolyte secondary battery as used in Example 1 was used. Evaluation results are shown in Table 2. Table 2 also shows the evaluation results of Example 1.

In Examples 1 and 3, a higher capacity retention ratio was obtained as compared to in Comparative Example 3. In Comparative Example 3, in which the second current I₂ was large, the Li dendrite formation became severe in the second and subsequent steps, which resulted in a low capacity retention ratio.

### Examples 4 and 5, Comparative Example 4

The currents I₁ to I₃ and the charge rates X₁ to X₃ of each step were set as shown in Table 3. Specifically, as in Example 2, the first current I₁ was set to 0.05 C (0.5 mA/cm²), and the second current I₂ was set to 0.4 C (4.0 mA/cm²). In Example 4, the third current I₃ was set to 0.5 C (5.0 mA/cm²), in Example 5, the third current I₃ was set to 0.6 C (6.0 mA/cm²), and in Comparative Example 4, the third current I₃ was set to 0.3 C (3.0 mA/cm²). The charge time of each step was set to the time determined in a similar manner to in Example 1. Except for the above, the charge-discharge cycle test was performed in the same manner as in Example 1. In the charge-discharge cycle test, the non-aqueous electrolyte secondary battery as used in Example 1 was used. Evaluation results are shown in Table 3.

In Examples 4 and 5, the charge time was short, and, a high capacity retention ratio was obtained. In Comparative Example 4, the charge rate in the third step was small, and the charge time was prolonged.

TABLE 1

| | Constant-current charging | | | | | | Capacity | Total |
|---|---|---|---|---|---|---|---|---|
| | First step | | Second step | | Third step | | retention | charge |
| | | First | | Second | | Third | ratio at | time at |
| | | charge | | charge | | charge | 100th | 100th |
| | First | rate X₁ | Second | rate X₂ | Third | rate X₃ | cycle | cycle |
| | current I₁ | (%) | current I₂ | (%) | current I₃ | (%) | (%) | (hr) |
| Ex. 2 | 0.05 C | 15 | 0.4 C | 50 | 0.6 C | 100 | 65.0 | 3.5 |
| Ex. 1 | 0.10 C | 15 | 0.4 C | 50 | 0.6 C | 100 | 65.6 | 2.4 |
| Com. Ex. 1 | 0.15 C | 15 | 0.4 C | 50 | 0.6 C | 100 | 63.3 | 2.0 |

| | | | |
|---|---|---|---|
| Com. Ex. 2 | Constant-current charging at 0.2 C to 4.1 V | 64.0 | 3.2 |

TABLE 2

| | Constant-current charging | | | | | | Capacity | Total |
|---|---|---|---|---|---|---|---|---|
| | First step | | Second step | | Third step | | retention | charge |
| | | First | | Second | | Third | ratio at | time at |
| | | charge | | charge | | charge | 100th | 100th |
| | First | rate X₁ | Second | rate X₂ | Third | rate X₃ | cycle | cycle |
| | current I₁ | (%) | current I₂ | (%) | current I₃ | (%) | (%) | (hr) |
| Ex. 3 | 0.1 C | 15 | 0.2 C | 50 | 0.6 C | 100 | 69.0 | 3.0 |
| Ex. 1 | 0.1 C | 15 | 0.4 C | 50 | 0.6 C | 100 | 65.6 | 2.4 |
| Com. Ex. 3 | 0.1 C | 15 | 0.6 C | 50 | 0.6 C | 100 | 60.3 | 2.2 |

TABLE 3

| | Constant-current charging | | | | | | Capacity | Total |
|---|---|---|---|---|---|---|---|---|
| | First step | | Second step | | Third step | | retention | charge |
| | | First | | Second | | Third | ratio at | time at |
| | | charge | | charge | | charge | 100th | 100th |
| | First | rate X₁ | Second | rate X₂ | Third | rate X₃ | cycle | cycle |
| | current I₁ | (%) | current I₂ | (%) | current I₃ | (%) | (%) | (hr) |
| Com. Ex. 4 | 0.05 C | 15 | 0.4 C | 50 | 0.3 C | 100 | 65.5 | 4.0 |
| Ex. 4 | 0.05 C | 15 | 0.4 C | 50 | 0.5 C | 100 | 65.4 | 3.7 |
| Ex. 5 | 0.05 C | 15 | 0.4 C | 50 | 0.6 C | 100 | 65.5 | 3.5 |

### Example 6

An electrolytic copper foil (thickness: 10 μm) was cut in a predetermined electrode size, to obtain a negative electrode current collector. A Li foil (thickness: 10 μm) was pressure-bonded to both sides of the negative electrode current collector (copper foil), to obtain a negative electrode. A non-aqueous electrolyte secondary battery was produced in the same manner as in Example 1, except that the negative electrode of the copper foil with a Li foil pressure-bonded to both sides thereof obtained above was used, instead of the negative electrode made of copper foil only. The molar ratio mLi/mMe of the amount mLi of total lithium in the positive electrode and the negative electrode to the amount mMe of the metal Me (here, Ni, Co and Al) in the positive electrode was 1.12.

Using the non-aqueous electrolyte secondary battery obtained above, in a 25° C. environment, the charge-discharge cycle test was performed in the same manner as in Example 1.

### [Evaluation]

The charge-discharge cycle test was performed 500 cycles in total, and the ratio of the discharge capacity at the 500th cycle to the discharge capacity at the 1st cycle was determined as a capacity retention ratio. In addition, the total charge time (the sum of the times for constant-current charging and constant-voltage charging) at the 500th cycle was determined. The evaluation results are shown in Table 4. Table 4 also shows the evaluation results of Example 1.

TABLE 4

| | | Constant-current charging | | | | | | Capacity | Total |
|---|---|---|---|---|---|---|---|---|---|
| | | First step | | Second step | | Third step | | retention | charge |
| | | | First | | Second | | Third | ratio at | time at |
| | | | charge | | charge | | charge | 100th | 100th |
| | Negative | First | rate X₁ | Second | rate X₂ | Third | rate X₃ | cycle | cycle |
| | electrode | current I₁ | (%) | current I₂ | (%) | current I₃ | (%) | (%) | (hr) |
| Ex. 1 | Copper foil | 0.1 C | 15 | 0.4 C | 50 | 0.6 C | 100 | 65.6 | 2.4 |
| Ex. 6 | Copper foil | 0.1 C | 15 | 0.4 C | 50 | 0.6 C | 100 | 84.0 | 2.8 |
| | with Li foil | | | | | | | | |

In Example 6, the charge time was short, and a high capacity retention ratio was obtained.

### INDUSTRIAL APPLICABILITY

The charging method for a non-aqueous electrolyte secondary battery according to the present invention is suitably applicable for a non-aqueous electrolyte secondary battery of a type in which a lithium metal deposits on a negative electrode current collector during charge and the lithium metal dissolves during discharge.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1: electrode group, 2: positive electrode lead, 3: negative electrode lead, 4: battery case, 5: sealing plate, 6: negative electrode terminal, 7: gasket, 8: sealing stopper, 11: non-aqueous electrolyte secondary battery, 12: charging apparatus, 13: external power source, 14: charging control unit, 15: voltage detection unit, 16: current detection unit

1. A charging method for a non-aqueous electrolyte secondary battery, the battery including
a positive electrode, a negative electrode including a negative electrode current collector, and a non-aqueous electrolyte, in which a lithium metal deposits on the negative electrode during charge, and the lithium metal dissolves in the non-aqueous electrolyte during discharge, the method comprising:
a charging step including a first step, a second step performed after the first step, and a third step performed after the second step, wherein
in the first step, a constant-current charging is performed at a first current I1 having a current density of 1.0 mA/cm2 or less,
in the second step, a constant-current charging is performed at a second current I2 being larger than the first current I1 and having a current density of 4.0 mA/cm2 or less, and
in the third step, a constant-current charging is performed at a third current I3 being larger than the second current I2 and having a current density of 4.0 mA/cm2 or more.

2. The charging method for a non-aqueous electrolyte secondary battery according to claim 1, wherein
in the first step, the constant-current charging is performed at the first current I1 of 0.1 C or less,
in the second step, the constant-current charging is performed at the second current I2 being larger than the first current I1 and 0.4 C or less, and
in the third step, the constant-current charging is performed at the third current I3 being larger than the second current I2 and 0.4 C or more.

3. The charging method for a non-aqueous electrolyte secondary battery according to claim 1, wherein in the first step, the constant-current charging is performed such that an amount of electricity to be charged in the first step becomes 15% or less of a total amount of electricity to be charged in the charging step.

4. The charging method for a non-aqueous electrolyte secondary battery according to claim 1, wherein in the second step, the constant-current charging is performed such that a summed amount of charged electricity in the first step and the second step becomes 50% or less of a total amount of electricity to be charged in the charging step.

5. The charging method for a non-aqueous electrolyte secondary battery according to claim 1, wherein
the negative electrode includes the negative electrode current collector, and a sheet of lithium metal in close contact with a surface of the negative electrode current collector, and
the negative electrode current collector is a copper foil or a copper alloy foil.

6. The charging method for a non-aqueous electrolyte secondary battery according to claim 1, wherein
the positive electrode includes a composite oxide containing lithium and a metal Me other than the lithium, and
the metal Me includes at least a transition metal.

7. The charging method for a non-aqueous electrolyte secondary battery according to claim 6, wherein a molar ratio mLi/mMe of an amount mLi of total lithium in the positive electrode and the negative electrode to an amount mMe of the metal Me in the positive electrode is 1.2 or less.

8. The charging method for a non-aqueous electrolyte secondary battery according to claim 6, wherein
the composite oxide has a layered rock-salt type crystal structure, and
the metal Me includes at least nickel as the transition metal.

9. The charging method for a non-aqueous electrolyte secondary battery according to claim 8, wherein the composite oxide is represented by a general formula (1): LiaNibM1-bO2, and in the general formula (1), 0.9≤a≤1.2 and 0.65≤b≤1 are satisfied, and M is at least one element selected from the group comprising Co, Mn, Al, Ti, Fe, Nb, B, Mg, Ca, Sr, Zr and W.

10. The charging method for a non-aqueous electrolyte secondary battery according to claim 1, wherein
the non-aqueous electrolyte contains lithium ions and anions, and
the anions include an oxalate complex anion.

11. The charging method for a non-aqueous electrolyte secondary battery according to claim 10, wherein the oxalate complex anion includes a difluoro(oxalate)borate anion.

12. A charging system for a non-aqueous electrolyte secondary battery, comprising:
a non-aqueous electrolyte secondary battery; and a charging apparatus, wherein
the non-aqueous electrolyte secondary battery includes a positive electrode, a negative electrode including a negative electrode current collector, and a non-aqueous electrolyte, in which a lithium metal deposits on the negative electrode during charge, and the lithium metal dissolves in the non-aqueous electrolyte during discharge, and
the charging apparatus includes a charging control unit that controls charging such that a first constant-current charging is performed at a first current I1 having a current density of 1.0 mA/cm2 or less, a second constant-current charging is performed after the first constant-current charging, at a second current I2 being larger than the first current I1 and having a current density of 4.0 mA/cm2 or less, and a third constant-current charging is performed after the second constant-current charging, at a third current I3 being larger than the second current I2 and having a current density of 4.0 mA/cm2 or more.

13. The charging system for a non-aqueous electrolyte secondary battery according to claim 12, wherein the charging control unit controls charging such that when an amount of charged electricity reaches a first threshold value in the first constant-current charging, the first constant-current charging is ended to start the second constant-current charging, and when the amount of charged electricity reaches a second threshold value in the second constant-current charging, the second constant-current charging is ended to start the third constant-current charging.

14. The charging system for a non-aqueous electrolyte secondary battery according to claim 13, wherein
the first threshold value is an amount of charged electricity corresponding to 15% or less of a total amount of electricity to be charged, and
the second threshold value is an amount of charged electricity corresponding to 50% or less of the total amount of electricity to be charged.
